(19) United States
(12) Patent Application Publication
(10) Pub. No.: US 2009/0051912 A1
(43) Pub. Date: Feb. 26, 2009

(54) Modular Microfluidic Flow Cytometer and Method Applications

(75) Inventors: Noe Antonio Salazar, Austin, TX (US); Joel Samuel Tabb, Slaterville Springs, NY (US)

Correspondence Address: BOND, SCHOENECK & KING, PLLC, 10 BROWN ROAD, SUITE 201, ITHACA, NY, 14850-1248, US

(73) Assignee: AGAVE BIOSYSTEMS, INC., Ithaca, NY (US)

(21) Appl. No.: 11/863,376

(22) Filed: Sep. 28, 2007

Related U.S. Application Data
(60) Provisional application No. 60/827,751, filed on Oct. 2, 2006.

(51) Int. Cl. G01N 21/05

(52) U.S. Cl. 356/246

(57) ABSTRACT

An embodiment of the invention is directed to a portable, modular, microscope mounted, microfluidic flow cytometry system. The system includes a microscope platform having an optical input/output port, imaging optics, and a sample stage; a sample illumination source module that is removably integrated with the optical input/output port; an optics module that is removably integrated with the sample excitation light source module and the optical input/output port; a detector module that is removably integrated with the optics module and the optical input/output port; a fluidic pump module having a fluidic input and a fluidic output, a first removable fluid conduit for connecting a fluid source to the input, and a second removable fluid conduit for connecting the output to an input of a microfluidic flow module; and, a system control and programmable data processing module. The system may further incorporate a microfluidic flow module positionable on the microscope sample stage having an output removably connectable to a fluidic waste collector. Method embodiments relating to applications of the microscope-mounted microfluidic flow cytometry system are also described.

### CROSS-REFERENCE TO RELATED APPLICATIONS

This application claims priority to U.S. Provisional application No. 60/827,751 filed on Oct. 2, 2006 under 35 USC § 119, the content of which is herein incorporated by reference in its entirety.

### STATEMENT REGARDING FEDERALLY SPONSORED RESEARCH OR DEVELOPMENT

This invention was made with Government support under contract no. NAS2-02045 awarded by the National Aeronautics and Space Administration and contract no. HHSN261200555000C awarded by the National Cancer Institute, National Institutes of Health. The Government has certain rights in the invention.

### BACKGROUND OF THE INVENTION

1. Technical Field

Embodiments of the invention are generally directed to the field of flow cytometry. More particularly, embodiments of the invention are directed to modularized flow cytometry apparatus and methods that are more efficient, less costly, and otherwise improved over traditional flow cytometry systems.

2. Background Art

Flow cytometers are used extensively in research and clinical laboratory settings for a wide range of applications including, but not limited to, cell cycle analysis, characterization of immune status, gene expression, immunoassay applications, and microbiological analysis. The vast majority of flow cytometry systems utilize a bank of lasers and photodetectors to detect and quantify optical scattering properties and fluorescent labeling properties of cells as they are flowed rapidly and precisely within an open, narrow stream of fluid.

Many of the current flow cytometry systems rely on a stream-in-air configuration, where the fluid stream is pumped through a microfluidic orifice and the sample passes through the laser light path in an open stream. Other systems utilize a small glass or quartz cuvette to contain the fluid stream as it passes through the laser light path. Flow cytometers based on this configuration have a number of advantages and disadvantages. Primary among the advantages of the traditional flow cytometry architecture is the high degree of optical sensitivity and robustness of these systems. Once the optics and fluidics are aligned, they are locked into place, so there is very little drift within the system. Some of the disadvantages of these systems are that they are quite expensive ($100 k-$750 k), they are large and not portable, and they require extensive time, expertise, and expense to use and maintain. Additionally, the open flow design (and hence the aspirated liquid that is an obligatory by-product of this design) used by many major flow cytometry manufacturers, makes these systems difficult to adapt for use with infectious disease or pathogenic microbiological samples.

There is therefore a need in the art for an improved flow cytometry system; particularly, one that is portable, modular in design, microscope-integrated, self-contained, and which comprises a sealed and, advantageously, disposable microfluidic flow cell component.

A modular, microscope-mounted, microfluidic flow cytometry system as embodied herein represents significant improvements in the field of flow cytometry. Typical conventional systems as described above are not constructed of modular components and therefore do not benefit from portability, efficiency of use, scope of application, reduced cost, integrated optics for sample visualization, ease of component exchange or replacement, and other recognized benefits, which are found in the flow cytometry embodiments described herein. The application of flow cytometry will advantageously benefit from a modular system that does not compromise conventional measurement sensitivity. The use of the optics of a standard research-quality microscope will dramatically decrease the cost and increase the portability, flexibility and safety aspects of a flow cytometry system. The reduction of size and complexity of the instrument can be accomplished without substantially decreasing the sensitivity, accuracy, and robustness of the instrument.

### SUMMARY OF THE INVENTION

An embodiment of the invention is a modular, microscope-integrated, microfluidic-based flow cytometry system. The system includes a microscope platform including an optical input/output port, imaging optics, and a sample stage; a sample illumination source module that is removably integrated with the optical input/output port; an optics module that is removably integrated with the sample excitation light source module and the optical input/output port; a detector module that is removably integrated with the optics module and the optical input/output port; a fluidic pump module having a fluidic input and a fluidic output, a first removable fluid conduit for connecting a fluid source to the input, and a second removable fluid conduit for connecting the output to an input of a microfluidic flow module; and a system control and programmable data processing module operatively connected to at least the sample illumination source module, the detector module, and the fluidic pump module, and further including a data output port. According to an aspect, the system further includes a microfluidic flow module that is disposable on the microscope sample stage and which has an output removably connectable to a fluidic waste collector. According to an aspect, the fluidic pump module further includes a fluidic waste collector; alternatively, a fluidic waste collection module is removably connectable to an output of the microfluidic flow module. In various aspects, the sample illumination source module comprises one or more of a diode laser, a light emitting diode (LED), a broadband light source, or a microscope lamp. The optics module comprises multi-color detection capability that operates with the microscope optics to provide detection of fluorescently labeled particles, cells, or light scattered by the particles or cells as they flow within the microfluidic module. The fluidic pump module includes one or more pumps that are capable of delivering microliter/sec volumes of fluid. A microfluidic pump controller provides precise computer control of sample and sheath buffer fluids. Electronic hardware and software control all aspects of the modular system. Computer software provides instructions to collect electro-optical data and convert that data into formats that can be used by standard third-party flow cytometry software packages.

The system advantageously provides a vast improvement over many of the fundamental limitations of current flow cytometry systems, not the least of which includes direct mounting on a microscope for use in virtually any environment. The ability to use this system on a preconfigured microscope dramatically reduces the overall cost of the instrumentation and opens up the utility of flow cytometry to any facility that has an existing microscope. The modular design of the system increases the portability of the system, making it ideal for use in, e.g., a bio-safety containment chamber, for field applications, and in developing countries where the cost and infrastructure associated with traditional flow cytometers make their use less feasible.

An embodiment of the invention is directed to a method for making microscope-based flow cytometry measurements. According to an aspect, a method is disclosed for directly measuring sample volume and particle or cell concentrations based on the accurately determined pumping flow rates and component volumes within the microscope-mounted, microfluidic flow cytometry system. According to an aspect, a method is disclosed for fluorescent detection in the quantification of DNA, RNA, or other nucleic acids simultaneously with antigens, antibodies, proteins, organelles, membrane components, toxins, drugs, hormones, small molecules, or other biologically important molecules. According to an aspect, a method is disclosed for fluorescent detection and quantitative analysis of fluorescently labeled cells with the quantitative detection of antibodies, antigens or other small molecules. According to an aspect, a method is disclosed for non-biological particle counting applications.

The features, benefits, scope, and advantages of the invention embodiments described herein will become more apparent to those skilled in the art in view of the attached drawings, the detailed description which follows, and the appended claims.

### BRIEF DESCRIPTION OF THE DRAWINGS

The embodiments of the invention are described herein with reference to the accompanying drawing figures. It is to be understood that in some instances, various aspects of the invention may be shown exaggerated or enlarged to facilitate an understanding of the invention.

FIG. 1. shows a schematic block diagram that illustrates the modular construction of a microscope-mounted, microfluidic flow cytometry system according to an embodiment of the invention;

FIG. 2 shows a schematic rendering of a microscope-mounted, microfluidic flow cytometry system according to an illustrative embodiment of the invention;

FIG. 3 shows a schematic diagram of a microfluidic module according to an illustrative embodiment of the invention; and

FIG. 4 shows a schematic view of a hydrodynamically focused sample flow through the channels of a microfluidic module according to an illustrative embodiment of the invention.

### DETAILED DESCRIPTION OF PREFERRED EMBODIMENTS OF THE INVENTION

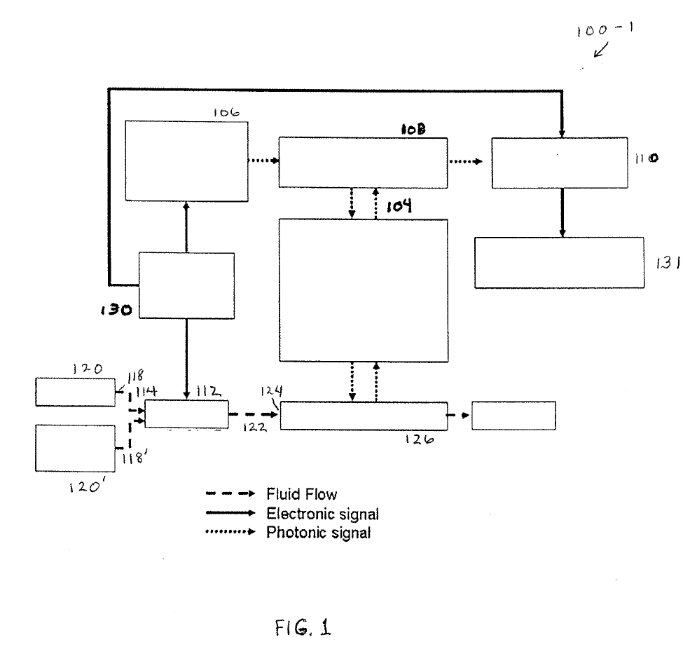

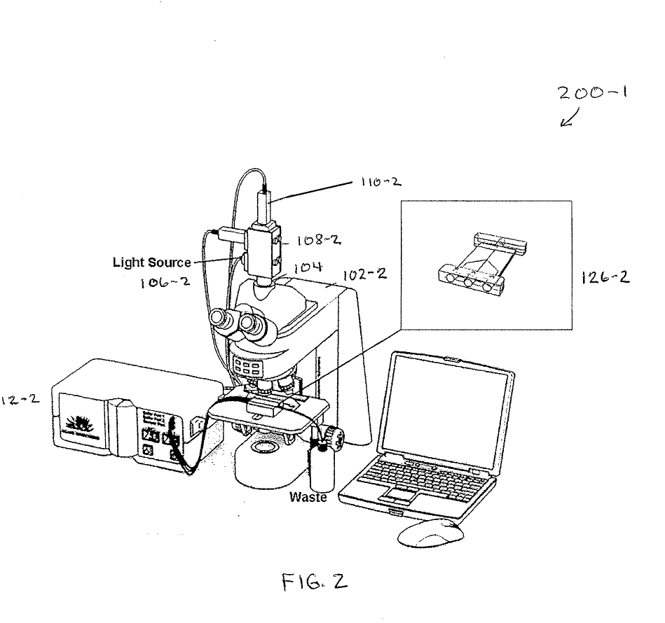

An illustrative portable, modularized flow cytometry apparatus 100-1 is schematically illustrated in FIG. 1. The system includes a microscope platform 102 including an optical input/output port(s) 104, imaging optics (per standard microscope optics; see FIG. 2), and a sample (specimen) stage (per standard microscope stage; see FIG. 2); a sample illumination source module 106 that is removably integrated with the optical input/output port; an optics module 108 that is removably integrated with the sample excitation light source module and the optical input/output port; a detector module 110 that is removably integrated with the optics module and the optical input/output port; a fluidic pump module 112 having a fluidic input 114 and a fluidic output 116, a first removable fluid conduit 118 for connecting a fluid source 120 (and, as shown, a sheath buffer 120′ via a removable fluid conduit 118′) to the input, and a second removable fluid conduit 122 for connecting the output to an input 124 of a microfluidic flow module 126 (described in greater detail below); a system control and programmable data processing module 130 (electronic control module) operatively connected to at least the sample illumination source module, the detector module, and the fluidic pump module, and further including a data collection and processing component 131.

As shown in the figure legend, fluid flow, electronic signal, and optical signal flow are illustrated by dashed-, solid-, and dotted-line arrows, respectively. Electronic input to control the illumination source and detector module integrates with the electronic control module. Signal output from the detector module is integrated into the data collection component of the electronic control module for data collection and processing.

An advantageous microscope platform 102 is a commercially available, research quality microscope such as, e.g., a Nikon Eclipse 80i, or a Zeiss Axioskop 40 or Axio Imager. FIG. 2 illustrates a laboratory system 200-1. The microscope includes interchangeable imaging optics and an adjustable specimen stage as generally standard microscope components.

The sample illumination source module 106 may include a laser, a light emitting diode (LED), a broadband light source, a high-pressure gas light source, or other source that provides suitable illumination for fluorescent detection of fluorescently labeled cells or particles and for the detection of particles by scatter detection. The illumination source 106 can be directly mounted to the microscope 102 or indirectly coupled into the microscope. The illumination source input may be mounted at a 90° angle with respect to the microscope optics, using direct input, optical fiber, or other optical coupling mechanisms known in the art. The light from the illumination source is coupled into the microscope using lenses, optical filters, and dichroic mirrors, which comprise the optics module 108 (described in further detail below). Optimal fluorescent excitation occurs when the excitation source is focused into an area approximately the diameter of the microfluidic channel (described in further detail below).

The optical illumination source, optical filters and dichroic mirrors, and photodetectors can be mounted in commercially available or specially designed, light-proof housings. These components may be removably mounted on the microscope on integrated camera ports, ocular ports, or other optical input/output housings 104 that are commonly available on the microscope.

The optics module 108 comprises various optical filters that function as optical excitation filters and optical emission filters. The excitation filter(s) removes light at unwanted wavelengths and only allows light of specific wavelengths to enter the microscope for optical excitation of the sample. Optical excitation filter wavelengths are chosen to match the fluorescent excitation wavelengths of specific dyes and/or particles under observation. An optical emission filter(s) is used to allow light emitted from the fluorescently labeled samples to pass out of the microscope for detection by the photodetector(s) of the detector module 110. A dichroic mirror(s) in the optics module allows light from the optical illumination source to be efficiently reflected into the microscope optical path and allows specific optical emission wavelengths to efficiently pass through the filter(s) to be detected by the photodetector(s). The optical excitation filter(s) will advantageously be positioned in a light-tight housing between the illumination source input and the dichroic mirror(s). The mirror(s) is advantageously oriented at a 45° angle with respect to the illumination source and the microscope optics to allow light to reflect off of the mirror and into the microscope optical path. The optical emission filter(s) is advantageously placed between the dichroic mirror(s) and the detector module 110.

The detector module 110 comprises detectors, which can include but are not limited to, photomultiplier tubes (PMTs), pin diode photodetectors, CCD cameras, and 1- and 2-dimensional arrayed detectors. Multiple photodetectors can be mounted onto the light-tight optics housing, which is removably mounted on the microscope camera or other optical input/output port 104. The detector module is advantageously mounted after the optic emission filter(s) so that only light fluorescently emitted from the particles or cells under analysis, or, light scattered by the particles or cells under analysis, is detected by the detector module.

A fluidic pump module 112, which is removably connected to the microscope platform, is provided to modulate flow rates and to begin and end pumping routines, thus allowing fluids to be delivered to, within, and out of the microfluidic module 122, which is mounted on the microscope stage, using one or more electronically controlled pumps. Standard microfluidic interconnects 116, 124 and microfluidic tubing 122 are used to integrate the pump module with the microfluidic module. Sheath buffer and sample fluids are pumped from reservoirs into the microfluidic module and fluidic waste is pumped from the microfluidic module to a waste reservoir for eventual decontamination and disposal.

The pumps can include a variety of types of pumping units, including but not limited to, direct drive pumps, screw driven syringe pumps, piston-driven syringe pumps, peristaltic pumps, diaphragm pumps, or other mechanically driven, low volume fluid delivery pump types. An exemplary pump is the MicroCSP-3000 (FIALabs, Bellevue, Wash.). The rate of fluid delivery by the pump(s) is electronically controlled by the electronic control module 130 software and firmware. Exemplary flow rates of 0.1 ml/min for the sheath flow channel and 0.01 ml/min for the sample channel have been demonstrated using existing microfluidic modules (125μ wide, 30μ high). Flow rates ranging from 10-fold slower to 10-fold faster can also work with this system.

A system control and programmable data processing module 130 (electronic control system) regulates all of the mechanical and electronic components of the microscope-mounted, microfluidic flow cytometry system, including but not limited to, the illumination source(s), the optical detection module(s), and the fluidic pump module. The electronic control system is comprised of microprocessors and software and firmware control programs that integrate and drive the fluid pumps, photodetector gain and output voltages, and laser output of the flow cytometry system. Electronic input and output ports can also be integrated into the electronic control system to allow direct integration with a personal computer, PDA, or other digital device for graphical user interface (GUI) and data collection, processing, and analysis, as shown at 131 in FIG. 1.

Data acquisition software at 131 is designed to collect data from the detection module 110 and process the eventual detection and analysis of fluorescent events. This component of the system control and programmable data processing module 130 advantageously includes, but is not limited to, a GUI, instrument set-up modules, noise and background thresholding and subtraction, peak detection algorithms, and file and data conversion routines that can be provided by a person skilled in the art. This system component is also advantageously designed to output files in standard flow cytometry data formats that are compatible with third-party flow cytometry analysis programs, such as, but not limited to FlowJo™ (Tree Star Inc), WinMDI™, or CellQuest (BD BioSciences).

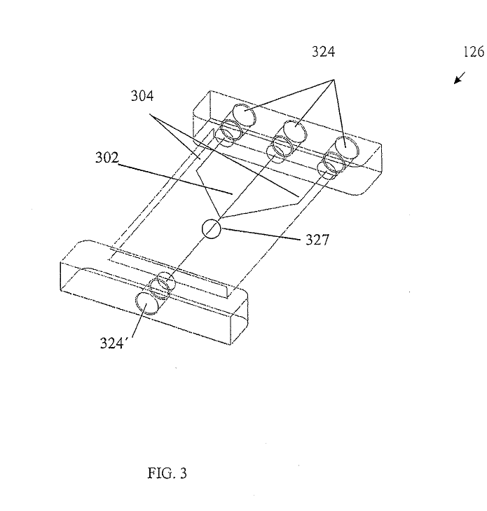

A principal auxiliary component of the modular flow cytometry apparatus is a two- or three-dimensional microfluidic module. FIG. 3 schematically illustrates a two-dimensional microfluidic module 126 according to an exemplary embodiment of the invention. The microfluidic module comprises flow channels, microfluidic interconnects, and an optical detection zone. More specifically, the exemplary two-dimensional microfluidic module 126 includes three fluidic inputs 324 at an input side 124 of the module that are adapted to couple the module to standard microfluidic interconnects; a sample channel 302 fluidically connecting the center input 324 and a waste output 324′ located at an output side of the module, and two sheath (or compression) flow channels 304 that are respectively fluidically connected to the two outer inputs 324 and which fluidically intersect the flow channel in a designated region; and an observation region 327 representing the optical detection zone.

The microfluidic module is intentionally designed to fit on the microscope specimen stage. The module architecture is further designed to take advantage of laminar flow that naturally occurs at the small dimensions found in microfluidic devices. The sheath flow buffer is pumped into the device and hydrodynamically compresses the sample into a tightly focused stream. By compressing the sample into a narrowly focused stream, particles within the sample can readily be aligned under the optical excitation beam for fluorescent detection and quantification. The microfluidic flow module is sealed, fully enclosed, and disposable, thus allowing users to analyze a wide variety of biological and non-biological samples, including potentially infectious samples, with significantly reduced risk of user or environmental contamination.

The sample channel(s) 302 can be etched, embossed, molded, machined or otherwise fabricated into a polymeric base. One or more sheath or compression flow channels 304 can be etched, embossed, molded, machined or otherwise fabricated into the polymeric module and merged with the sample channel to create two-dimensional or three-dimensional laminar, hydrodynamically focused fluid flow. An optical detection zone 327 for the detection of individual fluorescent particles or cells as they flow through the microfluidic module is located adjacent and downstream of the region of intersection of the channels. The waste output 324′ provides a pathway for delivery of fluid from the module to a waste reservoir that may be separate from, or integral with, the pump module 112.

Standard microfluidic tubing (e.g., 114) and interconnects provide for the integration of tubing from the fluidic delivery module to the microfluidic module/flow channels. Exemplary microfluidic interconnects include commercial microfluidic/nanofluidic connectors such NanoPort™ connectors available from Upchurch Scientific (Oak Harbor, Wash.); microfluidic plastic or silicone tubing integrated directly into the microfluidic channels; microbore stainless steel tubing, such as 20 gauge needle tubing available from Small Parts, Inc (Miami Lakes, Fla.). The interconnects can be integrated into the microfluidic module to deliver sheath buffer and sample to the modules and carry waste fluid from the module into a reservoir for storage, decontamination, and disposal.

A microscope quality glass coverslip or other optical quality transparent polymer that allows optical excitation, optical detection, and visualization of particles or cells as they pass through the detection area may advantageously be used to seal the microfluidic module. It is advantageous to the function of the module that there is no leakage from the interconnect sites at pressures up to 30 psi.

Thus the microfluidic module is designed so that it can be reused for several samples if the module has not contaminated, clogged, or otherwise deemed unusable for specific applications as necessary, but is also intended to be disposable and replaceable without undue expense.

Exemplary microfluidic modules can be fabricated by a variety of methods, including but not limited to: replicate molding using reverse molds and elastomeric materials such as PDMS (polydimethylsiloxane); micromachining; embossing; injection molding; and, direct etching of microchannels. Microfluidic flow cytometry modules may be fabricated using standard microfabrication technology in silicon, fused silica, glass, quartz, polymeric plastics, epoxy resins, photocatalytically- or heat-cured resins, silicone elastomer, or other optically appropriate materials that can accommodate microfabricated channels. The microfabricated modules advantageously are sealed to prevent leaking. Sealing can be accomplished by a number of methods including, but not limited to, sealing with high quality optical glass, polymers, silicon wafer, or other flat, optically appropriate materials. A large range of channel widths and heights ranging from microns (μ) to millimeters (mm) can be fabricated. In an exemplary configuration for use with cultured mammalian cells, well functioning microfluidic modules were configured with microfluidic channels 125μ across and 30μ high. Both dimensions can be readily increased or decreased depending on the nature of the particles being detected and the required analysis conditions. Microfluidic channels of other dimensions have also been experimentally constructed and tested, and were determined to function properly within the experimental microfluidic flow cytometry system.

According to an illustrative aspect, a sample is introduced into the microfluidic module through a single sample channel, and sheath buffer is introduced into the module through multiple sheath flow channels. The sample channel intersects the sheath flow channels at an angle greater than zero degrees and less than 90° to create a hydrodynamically focused flow in an observation region where the sample stream is compressed within the sheath fluid stream. In an experimental set-up, an angle of intersection of 45° worked well for a functioning microfluidic module. By controlling the relative flow rates of the sample and sheath flow fluids, the degree of sample stream compression can be precisely controlled. Two-dimensional and three-dimensional hydrodynamic focusing may be achieved by using multiple sheath flow channels for each sample channel.

Hydrodynamic focusing within the microfluidic module, created by using multiple sheath flow channels within the module, is functionally advantageous because it recreates the compression or sheath flow conditions that exist in a typical commercial flow cytometry system. Hydrodynamic focusing also helps eliminate the clumping of particles and dramatically reduces the likelihood of clogging of the microfluidic module. Focusing the sample stream within the module allows the module to be fabricated with channels significantly larger than the particles or cells that will be analyzed within the system. By focusing the sample stream, cells and particles are forced to align within the device so that they pass through the optical excitation filters and optical detectors individually. This reduces the likelihood of multiple particles or cells being detected simultaneously, and increases the sensitivity and reproducibility of the entire microscope-mounted flow cytometry system.

According to an alternative aspect of the invention, microfluidic modules may be microfabricated in parallel, on a single base, to provide microfluidic components capable of analyzing individual samples through parallel processing or analyzing multiple samples simultaneously.

An exemplary microscope-based microfluidic flow cytometry system 200-1 is now set forth with reference to FIG. 2. The system was mounted on a Nikon Opthiphot 2 microscope 102-2 equipped with a camera port 104. The optical illumination module 106-2 was mounted on the camera port using standard light tight fittings. The illumination source was a blue (473 nm), solid state laser (Oplink Fiber coupled semiconductor laser module) that was integrated into the optics module 108-2 using a single mode optical fiber cable (Thor Labs). The laser illumination source was focused into the microscope using a plano convex lens (Thor Labs D=12.7 mm f=30 mm). The optics module included two dichroic mirrors; one (Omega Optical 580DRLP Dichroic 18×26 mm) to direct the laser excitation beam through the microscope optics and focus it onto the microfluidic module 126-2; and a second (Omega Optical 505DRLP Dichroic 18×26 mm) to split the emission light collected from the module and direct the beams into the appropriate photodetector. To focus and collimate the emission light, the optical detection module 110-2 was equipped with an FC Collimation Package (Thorlabs F260FC-A). Two photosensor modules (PMTS; Hamamatsu) were used as photodetectors. The fluid delivery pump 112-2 was designed to provide pulse-free fluid pumping at rates from 0.001-1 ml/min. The pump was comprised of an OEM syringe pump system (Tecan) equipped with one 100 microliter and one 0.5 ml syringe. The pump was driven by a 24V power supply (Acopian) and housed in a LUX enclosure.

Another embodiment of the invention is directed to a method for making microscope-based flow cytometry measurements, particularly, using the microscope-based flow cytometry apparatus as disclosed herein to make measurements comprising counting fluorescent cells of virtually any type and/or fluorescent microspheres of virtually any type. Thus the disclosed apparatus particularly enables detecting and quantifying fluorescence inside or outside the cells, using antibodies, dyes, or other biomolecules to measure bio-related molecules and, detecting and quantifying fluorescence inside or outside to measure DNA, protein, or other biomolecules bound to the microspheres.

According to an aspect, the method involves a) detecting fluorescently labeled cells as they flow through a microfluidic module according to the apparatus embodiment described herein above, where cells may be, but are not limited to: i) cells isolated or grown from animals including both vertebrates and invertebrates; ii) single cell or multi-cellular eukaryotic species; iii) cells isolated or grown from plants; iv) yeast; v) fungus; vi) bacteria or archea cells; or, b) quantifying the fluorescence on and/or within the cell as the cells flow through the apparatus.

Another aspect is directed to a method wherein either: a) fluorescently labeled polymer, silica, magnetic, or other types of microspheres are detected as they flow through the apparatus; or, b) fluorescence on and/or within the microspheres is quantified as the microspheres flow through the apparatus.

Another aspect is directed to a method of using a microscope-mounted flow cytometry system to detect and quantify the fluorescence on cells, wherein either: a) fixed or unfixed cells are contacted with fluorescently labeled or unlabeled antibodies or other biomolecules specific for extracellular components such as, but not limited to, extracellular receptors, membrane proteins, lipids, cell wall components, and polysaccharide components; b) bound antibodies or other biomolecules such as, but not limited to, streptavidin, are either fluorescently detected directly or are contacted with fluorescently labeled secondary antibody or other binding components such as, protein A, protein G, or biotinylated proteins; c) the secondary antibodies or other binding components are either directly fluorescently detected or detected by contacting with a third protein or other biomolecule containing a fluorescent label.

Another aspect is directed to a method of using a microscope-mounted flow cytometry system to detect and quantify the fluorescence in cells, wherein fixed or unfixed cells are directly labeled with fluorescent dyes. The applications include, but are not limited to, propridium iodide or other DNA binding dyes for monitoring nucleic acid content, acridine orange or other pH sensitive dyes, dyes for monitoring intracellular pH, Ca²⁺-sensitive dyes for monitoring intracellular free Ca²⁺ levels, dyes for labeling lipid membranes, and dyes for measuring metal ion or reactive oxygen species within cells.

Another aspect is directed to a method of using a microscope-mounted flow cytometry system to detect and quantify the fluorescence on cells, wherein either: a) fixed or unfixed cells are contacted with proteins, antibodies or other biomolecules that enter the interior of the cell and bind to intracellular components; b) fixed or unfixed cells are contacted with permeabilizing agents such as, but not limited to, detergents, surfactants, organic solvents, pore forming agents; c) cells are contacted with fluorescently labeled or unlabeled antibodies or other biomolecules specific for intracellular components; d) bound antibodies or other biomolecules are either fluorescently detected directly or are contacted with fluorescently labeled secondary antibody or binding components; e) the secondary antibodies are either directly fluorescently detected or detected by contacting with a third protein or other biomolecule containing a fluorescent label.

Another aspect is directed to a method of using the disclosed microscope-mounted flow cytometry system to detect and quantify the presence of biomolecules on fluorescent microspheres, wherein; a) fluorescent microspheres, labeled in one color, are contacted with protein antigen, antibody or other biomolecule of interest and the biomolecules are chemically conjugated to the surface of the microsphere using standard bioconjugation chemistry; b) the biomolecule-conjugated microspheres are contacted with fluid mixture containing proteins, antibodies, or other biomolecules that bind specifically to the conjugated fluorescent microspheres; c) the unbound components of the fluid are removed from the microspheres by washing with excess buffer; d) the microspheres are then contacted with a biotin- or fluorescently labeled secondary antibody (labeled in a second color distinguishable from the microsphere fluorescence), specific for the bound antigen, antibody, or other biomolecule, followed by contact with a fluorescently labeled biotin binding protein if a biotin conjugated secondary antibody is used; e) the fluorescent microspheres with fluorescently labeled biomolecules on their surface are detected and quantified by flowing through the microscope mounted microfluidic flow cytometry system; and, f) quantifying fluorescence associated with: i) the microspheres to determine which type of microsphere was detected, and ii) the biomolecule to determine the level of biomolecule binding to each microsphere.

Another aspect is directed to a method of using a microscope-mounted flow cytometry system to detect and quantify the presence of specific DNA, RNA or other nucleic acid sequences in cells, wherein: a) fixed or unfixed cells are contacted with permeabilizing agents such as, but not limited to, detergents, surfactants, organic solvents, pore forming agents; b) cells are then contacted with fluorescently labeled or unlabeled oligonucleotides complementary to nucleic acid sequences found within the cells; c) cells are then heated and cooled to promote specific binding of the oligonucleotides; d) bound oligonucleotides are either: i) detected directly within the microscope mounted microfluidic flow cytometer; or, ii) incubated with a fluorescently labeled oligonucleotide specific for a short sequence on the nucleic acid of interest and is then detected directly within the microscope mounted microfluidic flow cytometer; or, iii) incubated with a fluorescently labeled oligonucleotide specific for the bound oligonucleotide and is then detected directly within the microscope mounted microfluidic flow cytometer.

Another aspect is directed to a method of using a microscope-mounted flow cytometry system to detect and quantify the presence of biomolecules on fluorescent microspheres, wherein: a) fluorescent microspheres, labeled in one color, are contacted with an oligonucleotide, specific for a gene or nucleic acid sequence of interest, and are chemically conjugated to the surface of the microsphere using standard nucleic acid chemistry; b) the oligonucleotide-conjugated microspheres are contacted with fluid mixture containing amplified or unamplified concentrations of nucleic acids; c) the unbound components of the fluid are removed from the microspheres by washing with excess buffer; d) the microspheres are then contacted with a biotin- or fluorescently labeled (labeled in a second color distinguishable from the microsphere fluorescence) oligonucleotides complementary to specific sequences within the gene or nucleic acid of interest, followed by contact with a fluorescently labeled biotin binding protein if a biotin conjugated secondary antibody is used; e) the fluorescent microspheres with fluorescently labeled oligonucleotides on their surface are detected and quantified by flowing through the microscope mounted microfluidic flow cytometry system; and, f) quantifying fluorescence associated with: i) the microspheres to determine which type of microsphere was detected, and, ii) the biomolecule to determine the level of nucleic acid binding to each microsphere.

An aspect of the invention also provides a method of using a microscope-mounted flow cytometry system to detect and quantify a combination of the applications described above including, but not limited to: a) detection of any combination of proteins, nucleic acids, small molecules, and other biomolecules on fluorescently labeled microspheres; and, b) detection of any combination of internal or external nucleic acids, membrane proteins, membrane components, membrane receptors, lipids, polysaccharides on fixed on unfixed cells.

The above described method embodiment, including providing a microscope-mounted flow cytometry system and microfluidic module, as described herein, provides the capability to perform the various recited measurement aspects of the invention more advantageously than can be performed with conventional flow cytometry apparatus. Various types and sizes and attributes of particles (cells, microspheres, etc.) can be analyzed without having to replace major components of the flow cytometer. For example, a measurement of larger particles can be performed according to the embodied method serially after a measurement of smaller particles simply by using a different disposable microfluidic flow module, rather than by having to replace the flow cell or capillary in a conventional system.

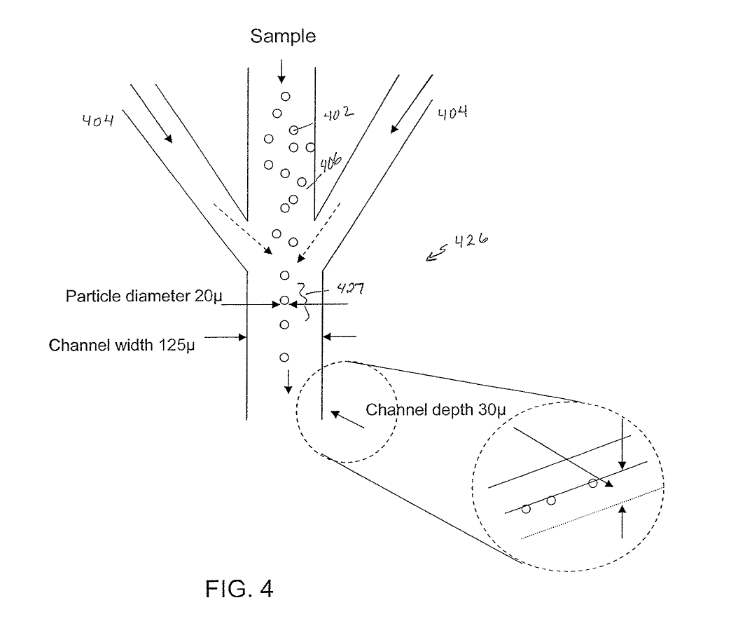

FIG. 4 schematically illustrates the hydrodynamic focusing (and single streaming) of microspheres 402 in the flow channel 406 of a representative microfluidic module 426. Illustratively, the flow channel has a width of 125μ and a channel depth of 30μ. The sample comprises 20μ diameter microspheres, which could, however, have a size range between about 1μ to 50μ changeable as a function of the flow rate of the sheath streams 404.

Experimentally, a flow rate of 1 μL/sec provided a dwell time of 33 μsec within the detection region 427 of the module for cells or microspheres approximately 10-30μ in diameter. Typical experiments can range from 1 to 10 minutes in length, though shorter or longer experiments are clearly feasible. At an expected rate of 20-40 events per second, an excess of 10,000 events can readily be analyzed in a typical experiment. The number of events detected in a single experiment can be increased by increasing the flow rate through the microfluidic module or analyzing samples for longer time intervals.

The foregoing description of the embodiments of the invention have been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A portable, modularized flow cytometry apparatus, comprising:
a microscope platform including an optical input/output port, imaging optics, and a sample stage;
a sample illumination source module that is removably integrated with the optical input/output port;
an optics module that is removably integrated with the sample excitation light source module and the optical input/output port;
a detector module that is removably integrated with the optics module and the optical input/output port;
a fluidic pump module having a fluidic input and a fluidic output, a first removable fluid conduit for connecting a fluid source to the input, and a second removable fluid conduit for connecting the output to an input of a microfluidic flow module;
a system control and programmable data processing module operatively connected to at least the sample excitation light source module, the detector module, and the fluidic pump module, and further including a data output port.

2. The apparatus of claim 1, further comprising a microfluidic flow module disposable on the sample stage having an output removably connectable to a fluidic waste collector.

3. The apparatus of claim 1, further comprising a fluidic waste collector that is removably connectable to an output of a microfluidic flow module.

4. The apparatus of claim 1, wherein the sample illumination source module includes at least one of a diode laser, a light emitting diode (LED), a broadband light source, and a microscope lamp.

5. The apparatus of claim 1, wherein the optics module comprises at least one of an optical detector, an optical filter, a collection lens, and a dichroic mirror.

6. The apparatus of claim 1, wherein at least two of the sample illumination source module, the optics module, and the detector module are a single modular unit.

7. The apparatus of claim 1, wherein the fluidic pump module further includes a fluidic waste collector having an input connectable to an output of a microfluidic flow module.

8. The apparatus of claim 1, wherein the system further includes a graphical user interface (GUI) operatively coupled to the control and programmable data processing module.

9. The apparatus of claim 1, wherein the microfluidic flow module comprises a sealed module.

10. The apparatus of claim 1, wherein the microfluidic flow module comprises a plurality of channels in fluid connection with a respective plurality of input ports, wherein at least one of the channels is a sample channel having an observation region and which is fluidly connected to an output port.

11. The apparatus of claim 1, wherein the at least one other channel is a sheath or compression flow channel, further wherein the at least one other channel intersects the sample channel at an angle greater than zero and less than 90 degrees.

12. A method for making microscope-based flow cytometry measurements, comprising:
providing a microscope-based flow cytometry apparatus that includes:
a microscope platform including an optical input/output port, imaging optics, and a sample stage; a sample illumination source module that is removably integrated with the optical input/output port; an optics module that is removably integrated with the sample excitation light source module and the optical input/output port; a detector module that is removably integrated with the optics module and the optical input/output port; a fluidic pump module having a fluidic input and a fluidic output, a first removable fluid conduit for connecting a fluid source to the input, and a second removable fluid conduit for connecting the output to an input of a microfluidic flow module; a system control and programmable data processing module operatively connected to at least the sample excitation light source module, the detector module, and the fluidic pump module, and further including a data output port; and a microfluidic flow module disposable on the sample stage having an output removably connectable to a fluidic waste collector;
flowing a plurality of at least one of fluorescently labeled cells and fluorescently labeled microspheres through a channel of the microfluidic module;
flowing a sheath fluid through at least one other channel of the microfluidic module;
quantifying the fluorescence on and/or within at least one of a cell and a microsphere as the cells or microspheres, respectively, flow through an observation region of the microfluidic module.

13. The method of claim 12, wherein the microspheres have a diameter between about 1μ to 50μ.

14. The method of claim 12, wherein the microspheres have a diameter between about 10-30μ.

15. The method of claim 12, wherein the plurality of the fluorescently labeled cells or the fluorescently labeled microspheres have a flow rate of between about 0.001 ml/min to 0.1 ml/min.
